(19) United States
(12) Patent Application Publication
(10) Pub. No.: US 2001/0048502 A1
(43) Pub. Date: Dec. 6, 2001

(54) LIQUID CRYSTAL DISPLAYS AND MANUFACTURING METHODS THEREOF

(76) Inventors: KYU-SUN MOON, KYUNGKI-DO (KR); BYUNG-HOO JUNG, SEOUL (KR)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 09/223,275

(22) Filed: Dec. 30, 1998

(30) Foreign Application Priority Data
Dec. 31, 1997 (KR) 97-80198

(51) Int. Cl. G02F 1/1339

(52) U.S. Cl. 349/153

(57) ABSTRACT

A sealant pattern is interposed between an upper substrate having a common electrode and a lower substrate having a display area and driving circuits, and surrounds the display area. A liquid crystal layer is formed between the two substrates and inside the display area. Since the liquid crystal layer is not interposed between the driving circuits and the common electrode, a parasitic capacitance generated between bus lines of the driving circuits and the common electrode can be reduced. Moreover, it is possible to form an additional sealant pattern surrounding the driving circuits and inject a material having a lower dielectric constant than the liquid crystal into a region sealed off by the two sealant patterns.

### BACKGROUND OF THE INVENTION

(a) Field of the Invention

The present invention relates to liquid crystal displays and manufacturing methods thereof.

(b) Description of the Related Art

Liquid crystal displays (LCDs) widely used as a flat panel display includes two substrates having electrodes generating electric fields and a liquid crystal layer injected between the two substrates.

Thin film transistor liquid crystal displays (TFT-LCDs) use TFTs as switching devices. According to the material used for channel layers of the TFTs, there are two types of TFT-LCDs. One is an amorphous silicon TFT-LCD and the other is a polycrystalline silicon TFT-LCD. The polycrystalline silicon TFT-LCD can form driving circuits of the LCD on one substrate of the LCD panel. It can reduce manufacturing costs and improve the image quality.

In a conventional LCD panel, the driving circuits are formed inside a region surrounded by a sealant and overlap a transparent common electrode of a corresponding substrate. A liquid crystal layer is formed between bus lines of the driving circuits and the common electrode. Therefore, a parasitic capacitance is generated between the bus lines and the common electrode.

The parasitic capacitance delays the signals passing through the bus lines of the driving circuits and increases the time to charge the display signals into pixels. As a result, the parasitic capacitance hinders the operation of the driving circuits and deteriorates the image quality of the LCD. As TFT-LCDs become larger with a high resolution, the worse the quality of the LCD.

### SUMMARY OF THE INVENTION

It is an object of the present invention to reduce a parasitic capacitance between bus lines of driving circuits built on a substrate of an LCD and a common electrode to enhance the operation of the driving circuits.

It is another object of the present invention to provide adequate methods of manufacturing LCDs.

To achieve these objects of the present invention, a sealant sealing two substrates surrounds only pixel regions and isolates driving circuits from the pixel regions. Since a liquid crystal layer contacts only the pixel regions and is not interposed between the driving circuits and the common electrode, a parasitic capacitance generated by overlapping driving circuits and a common electrode can be reduced.

In order to prevent the driving circuits from exposing to an external atmosphere, another sealant region can be added outside the first sealant region to form a double-lined structure of the sealant regions surrounding the driving circuits. In addition, a material of a dielectric constant lower than the liquid crystal injected into the region closed by the double-lined sealant may reduce the parasitic capacitance.

To achieve the above-mentioned object, in another embodiment of the present invention, driving circuits and pixels are formed on a lower substrate and color filter patterns and the transparent common electrode are formed on an upper substrate facing the lower substrate. The common electrode does not overlap the regions where the driving circuits are formed.

The LCD can be manufactured by depositing a transparent conductive film for a common electrode on the upper substrate and then removing a portion of the transparent conductive film facing the driving circuits of the lower substrate.

As a result, the removal of the common electrode facing the driving circuits minimizes the parasitic capacitance between the common electrode and the driving circuits.

### BRIEF DESCRIPTION OF THE DRAWINGS

FIG. 1 is a schematic diagram of a structure of an LCD panel according to the first embodiment of the present invention;

FIG. 2 is a cross sectional view taken along line II-II′ in FIG. 1;

FIG. 3 is a schematic diagram of a structure of an LCD panel according to the second embodiment of the present invention;

FIG. 4 is a cross sectional view taken along line IV-IV′ in FIG. 3;

FIGS. 5 and 6 are graphs showing driving signal delays due to the parasitic capacitance of the LCD panel;

FIG. 7 is a schematic diagram of a structure of an LCD according to the third and the fourth embodiments of the present invention;

FIG. 8 is a cross sectional view taken along line VIII-VIII′ in FIG. 7 according to the third embodiment of the present invention; and

FIG. 9 is another cross sectional view taken along line VIII-VIII′ in FIG. 7 according to the fourth embodiment of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be constructed as limited to the embodiments set forth herein. In the drawings, the thickness of layers and regions are exaggerated for clarity. Like numbers refer to like elements throughout. It will be understood that when an element such as a layer, region or substrate is referred to as being “on” another element, it can be directly on the other element or intervening elements may also be present.

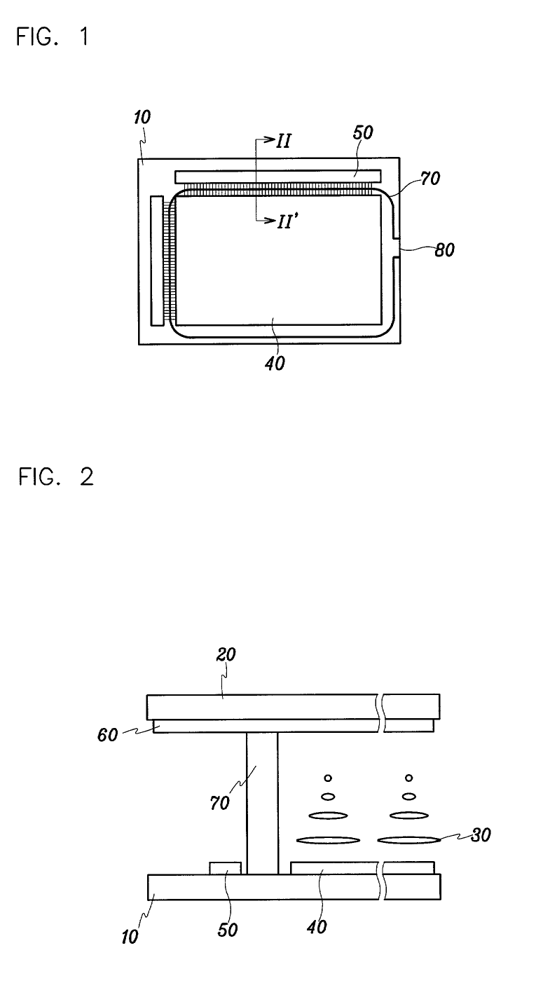

FIGS. 1 and 2 show a structure of a TFT-LCD panel according to the first embodiment of the present invention.

FIG. 1 is a schematic diagram of a lower panel of an LCD, and FIG. 2 is a cross sectional view taken along line II-II′ in FIG. 1.

As shown in FIGS. 1 and 2, the LCD panel according to the first embodiment includes a lower substrate 10 and an upper substrate 20. A display area 40 having pixel electrodes and TFTs and driving circuits 50 are formed on the lower substrate 10. A common electrode 60 is formed on the upper substrate 20. The common electrode 60 faces the driving circuits 50 of the lower substrate 10, because it is formed all over the upper substrate 20.

In this embodiment, channel layers of transistors of the driving circuits 50 and the TFTs in the display area 40 are made of polycrystalline silicon.

A sealant pattern 70 having an injection hole 80 is applied along the edges of the lower substrate 10 and assembles the lower substrate 10 and the upper substrate 40. A liquid crystal layer 30 is injected into the region surrounded by the sealant pattern 70 and interposed between the substrates 10 and 20. The driving circuits 50 are located outside the region surrounded by the sealant pattern 70.

As the driving circuits 50 are located outside the region surrounded by the sealant 70 and air has a smaller dielectric constant than that of the liquid crystal, which is about 2-3, the parasitic capacitance due to the overlapping of the driving circuits 50 and the common electrode 60 is reduced.

However, in the structure shown in FIGS. 1 and 2, the driving circuits 50 may be damaged by moisture of the air, which decreases the reliability of the driving circuits 50. To solve this problem, the sealant may be formed with double lines.

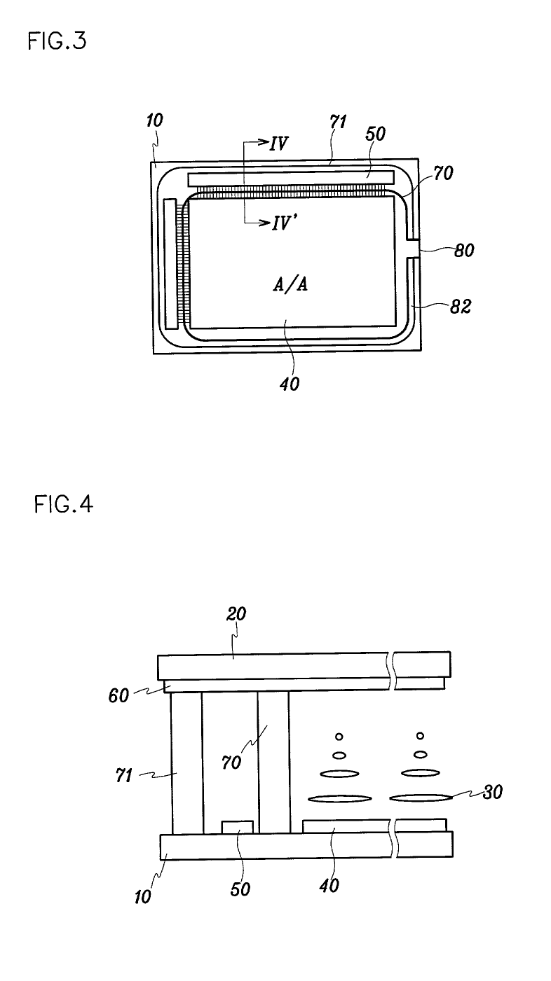

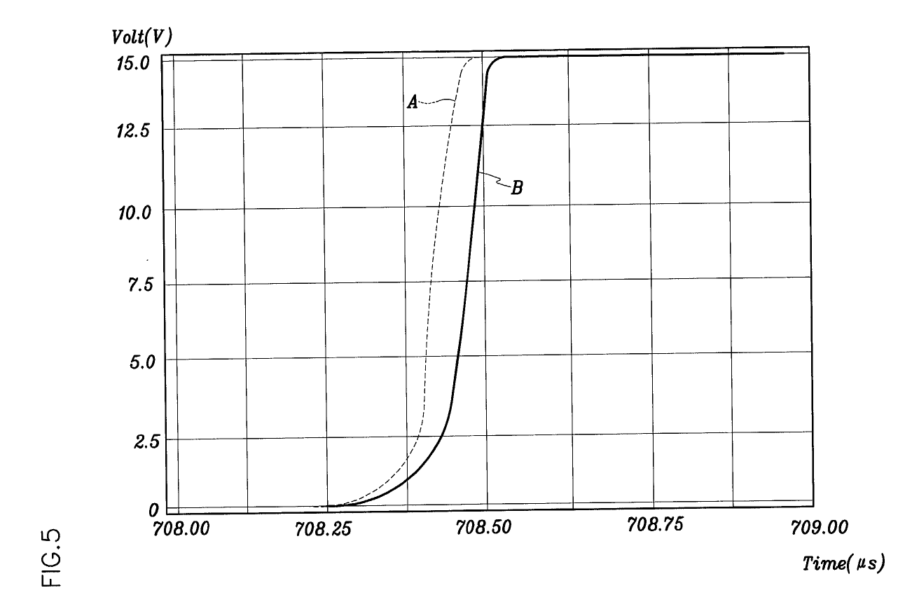

Now, the second embodiment of the present invention is described with reference to FIGS. 3 and 4.

FIG. 3 is a schematic diagram of a lower substrate, and FIG. 4 is a cross sectional view taken along line IV-IV′ in FIG. 3.

As shown in FIGS. 3 and 4, the structure of the second embodiment of the present invention is almost the same as that of the first embodiment except that the sealant pattern has a double-lined structure including the first sealant pattern 70 and the second sealant pattern 71.

The first and the second sealant patterns 70 and 71 are applied to a lower substrate 10. The first sealant pattern 70 surrounds a display area 40 and has an injection hole 80 which is opened toward an edge of the substrate 10. The second sealant pattern 71 is located outside the first sealant pattern 70 and surrounds the driving circuits 50. That is, the driving circuits 50 are located inside the region surrounded by the first sealant pattern 70 and the second sealant pattern 71.

If a screen printing method is used to form the double-lined sealant patterns 70 and 71, no additional step is required.

Also, it is possible to use another method, a dispenser method using an apparatus moving along the preferred axis with a container having nozzles, from which the sealing material spouts out.

Contained by the sealant patterns 70 and 71, the driving circuits 50 are not affected by the external environment.

Oil, a material of a dielectric constant lower than the liquid crystal injected into the regioncontaining the driving circuits 50 may also reduce the parasitic capacitance. In this case, an additional injection hole is required.

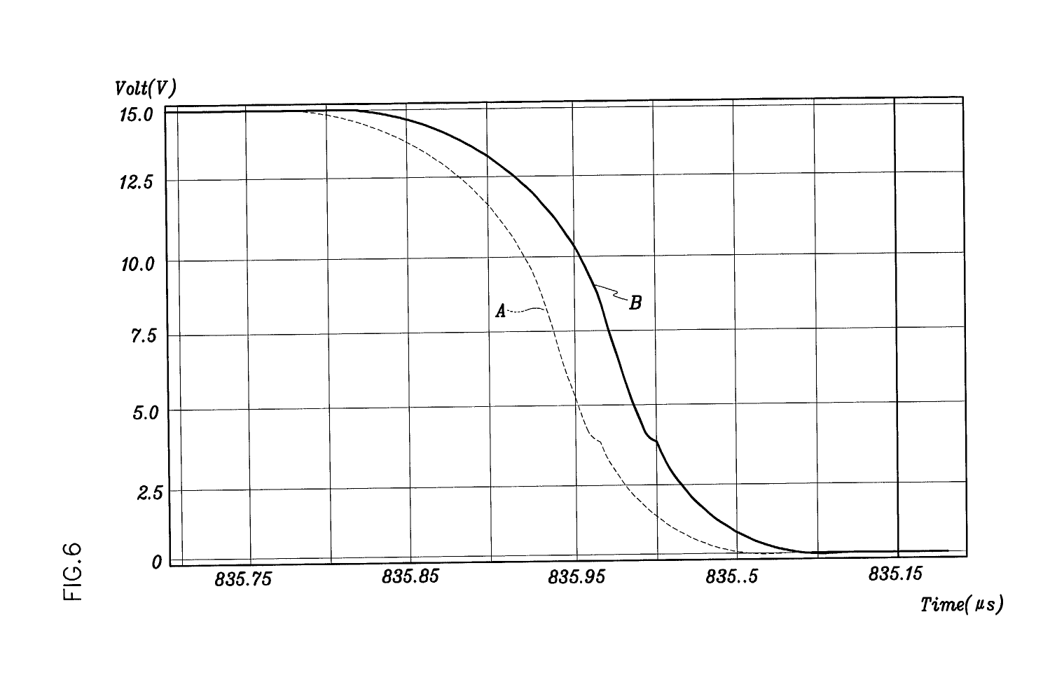

As an example of the signal delay effects according to the decrease of the parasitic capacitance, FIGS. 5 and 6 show simulations of the delay effects of output enable signals, which are driving signals applying display signals to pixels according to each horizontal line. FIGS. 5 and 6 show a simulation of a parasitic capacitance between the clock signal lines and each node of the signal line in an LCD panel of a 5 inch size and 16:9 screen ratio.

FIG. 5 shows a part of the rising edge of the output enable signals, and FIG. 6 shows a part of the falling edge of the output enable signals. A curve represents the case where there is no liquid crystal between the driving circuits and the common electrode, and B curve represents the case where there is a liquid crystal layer between the driving circuits and the common electrode.

As shown in FIGS. 5 and 6, the signal delay when no liquid crystal is laid between the driving circuits and the common electrode, is smaller than that when the liquid crystal is interposed therebetween. It is because that the dielectric constant of air is smaller that that of liquid crystal and a parasitic capacitance is proportional to the dielectric constant. Therefore, if injected into the region closed by the double-lined sealant, a material having a lower dielectric constant than the liquid crystal can further reduce the parasitic capacitance.

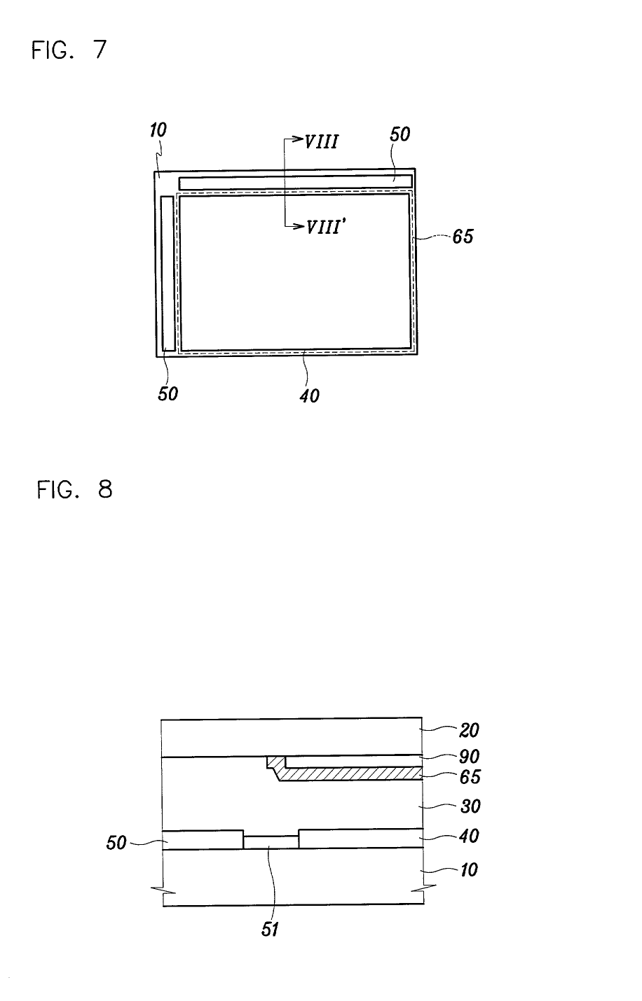

Now, structures of LCD panels according to the third and the fourth embodiments of the present invention are described with reference to FIGS. 7 through 9.

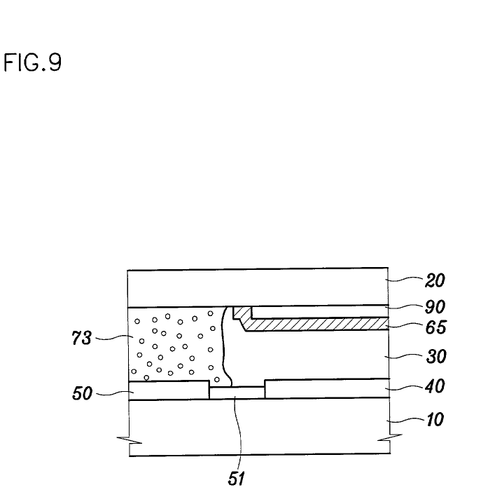

FIG. 7 is a schematic diagram of structures of LCD panels according to the third and the fourth embodiments, FIG. 8 is a cross sectional view taken along line VIII-VIII′ in FIG. 7, and FIG. 9 is another cross sectional view taken along line VIII-VIII′ in FIG. 7.

As shown in FIGS. 7 through 9, a display area 40 having a plurality of pixels including thin film transistors (not shown), a gate wire (not shown), a data wire (not shown) and pixel electrodes (not shown) is formed on a lower substrate 10, and driving circuits 50 such as data drivers and gate drivers are formed outside the display area 40. The display area 40 is connected to the driving circuits 50 by a wire 51.

Color filters 90 are formed on an upper substrate 20, and a transparent common electrode 65 is formed on the color filters 90. A portion of the common electrode 65 facing the driving circuits 50 on the lower substrate 10 is removed, so that the common electrode 65 and the driving circuits 50 do not overlap after assembling the two substrates 10 and 20.

A liquid crystal is injected between the two substrates 10 and 20. The liquid crystal layer 30 is interposed between the driving circuits 50 and the upper substrate 20 as shown in FIG. 8, or a sealant 73 is interposed therebetween as shown in FIG. 9.

To manufacture this LCD, color filters 90 are formed on the upper substrate 20, and a transparent conductive film is deposited thereon and patterned to form a common electrode. In the step of patterning, a portion of the common electrode which will face driving circuits of the lower substrate is removed.

As described above, the LCD according to the present invention, locating the driving circuits outside the liquid crystal injection region, or removing the common electrode opposite the driving circuits, can minimize a parasitic capacitance generated by the common electrode and the driving circuits. This can prevent a hindrance of the operation of the driving circuits due to the parasitic capacitance and improve the image quality of the LCD.

In the drawings and specification, there have been disclosed typical preferred embodiments of the invention and, although specific terms are employed, they are used in a generic and descriptive sense only and not for the purpose of limitation, the scope of the invention being set forth in the following claims.

What is claimed is:

1. A liquid crystal display comprising:
a lower substrate including a display area having pixel electrodes and thin film transistors, and driving circuits located outside the display area;
an upper substrate facing the lower substrate and having a common electrode;
a first sealant pattern interposed between the lower substrate and the upper substrate and surrounding the display area; and
a liquid crystal layer interposed between the lower and the upper substrates of the display area.

2. The liquid crystal display of claim 1, wherein the thin film transistors and the driving circuits have polycrystalline silicon channels.

3. The liquid crystal display of claim 1, further comprising a second sealant pattern surrounding the first sealant pattern, wherein the driving circuits are located in a first region surrounded by the first and the second sealant patterns.

4. The liquid crystal display of claim 3, further comprising a material layer of a dielectric constant lower than that of the liquid crystal in the first region interposed between the lower and the upper substrate.

5. A liquid crystal display comprising:
a first substrate including driving circuits and pixels; and
a second substrate facing the first substrate and including a transparent common electrode and color filters,
wherein a portion of the common electrode opposite the driving circuits is removed.

6. A manufacturing method of a liquid crystal display, comprising the steps of:
forming color filters on a first substrate;
forming a transparent common electrode covering the color filters on the first substrate;
removing a portion of the common electrode that is going to face driving circuits; and
assembling the first substrate and a second substrate having driving circuits, wherein the portion of the common electrode is the driving circuits.
